(19) United States
(12) Patent Application Publication
(10) Pub. No.: US 2012/0315430 A1
(43) Pub. Date: Dec. 13, 2012

(54) Decorated Part of an Assembly and Manufacturing Process Therefor

(76) Inventors: Christopher D. ROBERTS, Elwood, IL (US); Douglas A. MARCINIAK, Orland Park, IL (US); Joel R. LEE, Peotone, IL (US); Todd HENNEIKE, Bourbonnais, IL (US); Douglas P. WENDLING, Manteno, IL (US); David J. BONADONA, Steger, IL (US); Todd I. CALLISTER, Chicago, IL (US)

(21) Appl. No.: 13/469,347

(22) Filed: May 11, 2012

Related U.S. Application Data
(60) Provisional application No. 61/496,413, filed on Jun. 13, 2011.

(51) Int. Cl. B32B 3/02; B29C 45/14

(52) U.S. Cl. 428/76; 264/104; 156/245; 428/68

(57) ABSTRACT

A decorated part for an assembly includes a decorative skin and a body, the skin wrapping an edge of the body so that adjacent edges of adjacent parts in the assembly do not expose the body. The process for making the part includes first vacuum forming the skin from a film, loading the formed skin into a mold and forming the body against the pre-formed skin.

### CROSS-REFERENCE TO RELATED APPLICATIONS

The present application claims the benefits of U.S. Provisional Application Ser. No. 61/496,413 filed on Jun. 13, 2011.

### FIELD OF THE INVENTION

The present invention relates generally to plastic parts having decorated surfaces, such as, for example, the parts of an automotive door handle assembly that is located on the interior or exterior door panel and serves as an aesthetic component as well as a functional component to release the latching mechanism of the door; and to processes for providing the desired surface finish on such parts.

### BACKGROUND OF THE INVENTION

Various techniques and processes are known for providing surface finishes on automobile parts, such as door handles, and on other assemblies. In some assemblies, adjacent components are made of different materials, yet it is desired that the parts have similar surface finishes. For example, automobile bodies are often made of metal or other materials and spray-painted for the desired finish. Handles provided on a door assembly to operate the latch mechanism often are made of injection molded plastic and finished to complement, contrast or otherwise provide an aesthetically desirable relationship with the painted body. For example, it is known to provide the door handle with various types of chrome finishes, such as fully chrome plated handles. It is also known to provide painted or other surface finishes on the door handle. Painting and plating processes are sometimes considered environmentally unfriendly in that waste materials, such as solvents used for cleaning the equipment, can be expensive to dispose of properly and environmentally hazardous if disposed of improperly.

While various finishing techniques have achieved certain levels of acceptance, the processes are not without drawbacks. For example, in order to have a vehicle color decoration on the handle it has been necessary to paint the handle after molding. This can increase the cost of providing the handle in that a separate additional step is required after molding, which may be at a distant location from the molding process. Delay in achieving a finished part is undesirable. When a chrome-finished handle is desired, it has been necessary to apply chrome plating after molding, which can be expensive and environmentally unfriendly. Further, it is now known to transmit electronic signals through the door handle to operate the door latch and/or for security purposes. However, electronic signals do not transfer readily through the chrome plated door handles.

It is known also to provide a skin or covering on outer surfaces of plastic parts to provide simulated chrome, simulated wood grain, color or other surface finishes. The films suitable for this use are durable and can provide improved wear against tarnishing, discoloration and the like as compared to painted or plated finishes. However, known processes have been suitable only for covering the primary exposed surface of the part, and edges of the parts have remained uncovered. Some components finished in this way are provided as multiple part assemblies. For example, a door handle can have a generally fully visible outside part and a less visible, but partially visible inside part. The inside part and outside part are fitted together in the final assembled handle. Film-covered components, such as door handles, have had discernible dark lines where the two separate parts join, in that the base material of the handle parts can be visible along the abutting adjacent surfaces, since the films used to cover the parts have not fully wrapped edges of the parts. Aesthetically, the dark lines visible between adjoining parts are undesirable.

### SUMMARY OF THE INVENTION

The present invention provides a process that achieves precise and rigid union of two or more decorated components, and that achieves and maintains specific tolerances and cosmetic requirements. Multiple parts can be decorated using an in-mold decoration process, thereby providing a finished part at the conclusion of the injection molding process. Each part is decorated in such a way that the decoration wraps the edges of the part and can encompass the entire perimeter of the part. As a result, when two or more parts are assembled together, the decorated edges come together to completely hide all substrate material in the finished assembly. No substrate will be visible unless the design specifically calls for the substrate to be visible.

In one embodiment, a decorated part for an assembly including the part is provided with a pre-formed skin made from a film having a desired decorative appearance, the skin formed independently in a shape of a desired visible surface of the assembly; and a body of the part formed by molding against an inner surface of the pre-formed skin.

In another embodiment, an assembly of decorated parts is provided with at least a first part and a second part, each having a pre-formed skin and a body. Each pre-formed skin is a vacuum formed inlay from a film having a desired decorative appearance. Each body is formed by molding onto a one of the pre-formed skins. The parts have adjacent edges, and the skins encompass the adjacent edges.

In a further embodiment, a process for manufacturing decorated parts includes thermoforming a decorative film into an inlay skin having the outer shape of at least a portion of the part; loading the thermoformed skin into a plastic molding machine; and injecting material for a body of the part into and against the thermoformed skin such that at least portions of edges of the finished part are covered by the thermoformed skin.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of a decorated automobile door handle assembly;

FIG. 2 is a plan view of the decorated door handle assembly;

FIG. 3 is a cross-sectional view of the decorated door handle assembly shown in FIGS. 1 and 2, the cross section taken along line 3-3 of FIG. 2;

FIG. 4 is a is an enlarged, fragmentary view of a portion of the decorated door handle assembly as shown in FIG. 3;

FIG. 5 is a cross-sectional view of the decorated door handle assembly shown in FIGS. 1-4, the cross section taken along line 5-5 of FIG. 2;

FIG. 6 is an enlarged, fragmentary view of a portion of the decorated door handle assembly as shown in FIG. 5;

FIG. 7 is a partially exploded view of the film used in the decorated door handle assembly;

FIG. 8 is a perspective view of the film on process equipment used for making the decorated door handle assembly;

FIG. 9 is a cross-sectional view through the film and process equipment shown in FIG. 8, the cross-section taken along line 9-9 of FIGS. 8; and

FIG. 10 is an exploded view of outer skins of the decorated door handle assembly.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

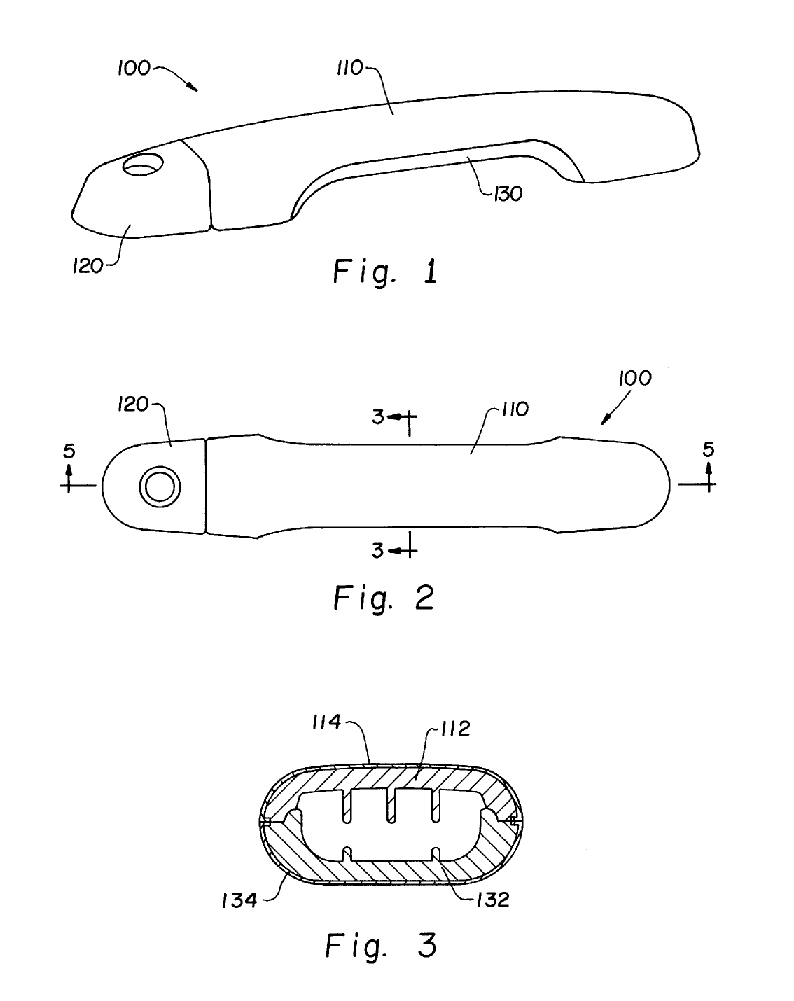

Referring now more particularly to the drawings, FIG. 1 shows an automobile door handle assembly 100 that includes three separate parts, a main outer part 110, an end part 120 and an inside grip part 130 that are manufactured individually and then joined to form door handle assembly 100.

While an exemplary automobile door handle assembly 100 is shown and described herein, it should be understood that the processes, concepts and structures disclosed can be used for a variety of different parts for automobiles and for parts of many assemblies other than automobiles.

As illustrated in the exemplary embodiment, each of the parts 110, 120, 130 is made of an injection molded plastic body with a film covering or skin on the primary exposed surfaces of the part, and with sufficient wrap around the edge surfaces of the part so that, when the parts are assembled together, no body material of the part is exposed. Accordingly, main outer part 110 includes a main outer part body 112 and a main outer part skin 114; end part 120 includes an end part body 122 and an end part skin 124; and inside grip part 130 includes an inside grip part body 132 and an inside grip part skin and 134.

A thermoform inlay or insert molding process is used in making main outer part 110, end part 120 and inside grip part 130, whereby the respective skins 114, 124, 134 thereof are formed first by vacuum molding. The skins 114, 124, 134 are then loaded into a trim mold and trimmed, and thereafter plastic for the respective bodies 112, 122, 132 of the parts 110, 120, 130 is formed by injection molding into, on and/or against the pre-formed skins 114, 124, 134.

To create the skins 114, 124, 134, a film 140 is fed from a supply roll 142 of the film, cut to suitable size for the process, and transferred to a vacuum thermoforming mold 160. At the vacuum thermoforming mold 160, film 140 is formed by known techniques into the exterior shape of the part, including a complete wrap at edges that will be visible in the completed assembly. Accordingly, a flange of some limited width is provided as a return at each exposed edge, such as along the face of the part that will join a second part in the completed assembly.

As shown in FIG. 7, an exemplary film 140 may consist of multiple layers, including an extruded substrate 144, a color coat layer 146, a pattern layer 148, a clear coat layer 150 and a carrier layer 152. Such films are well-known and can be obtained in desirable colors for automobile finishing, including colors coordinated with vehicle body colors, simulated chrome, simulated wood grain and the like. Such films are known and used in the automotive industry in other surface finishing processes and for other purposes. One of the layers can form an electrically conductive layer for the transmissions of signals in security and operating systems of the vehicle.

As those skilled in the art will understand readily, film 140 is provided on roll 142, and is trimmed to suitable size to fit on the vacuum thermoforming mold 160. The cut piece is loaded onto the thermoforming machine, heated to be compliant and lowered over the forming tool. Vacuum is drawn beneath the film so that the film is drawn against and conforms to the shapes of the thermoforming mold parts. FIG. 8 shows the vacuum formed film 140 and thermoforming mold 160 before the already formed film is removed from the thermoforming mold 160.

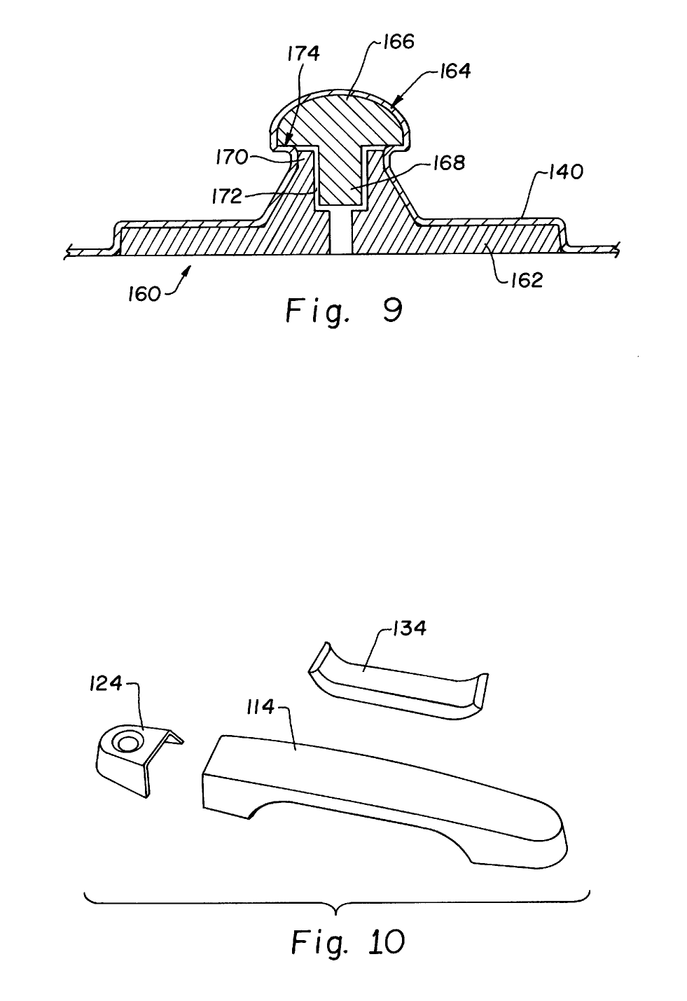

FIG. 9 is a cross-sectional view of the vacuum formed film 140 on vacuum thermoforming mold 160. Film 140 has been heated and vacuum formed to conform to the outer surfaces of the mold, including a mold base 162 and a mold insert 164. Mold insert 164 has a generally mushroom shaped cross-sectional configuration, with a cap 166 and a stem 168. Stem 168 fits into a vacuum channel portion 170 of mold base 162. In the assembled vacuum thermoforming mold, a vacuum flow path 172 exists along the undersurface of cap 166 and along the sides of stem 168. As can be seen at the edge area indicated by 174 in FIG. 9, the film is drawn toward flow path 172 to completely wrap edge area 174, including a short segment of the undersurface of mold cap 166 that extends laterally of the outer surface of channel portion 170. While FIG. 9 depicts the formation of skin 114, it should be understood that skins 124 & 134 can be formed in similar ways. Accordingly, each skin 114, 124, 134 includes an outer segment 116, 126, 136, respectively, and an edge return segment 118, 128, 138 respectively.

After the film is formed and re-hardened, it is removed from the vacuum thermoforming mold 160 and is trimmed using a trim die having side actions that cut underneath the wrapped corners while leaving sufficient width that the edges are fully wrapped.

FIG. 10 shows the formed film inlay skins 114, 124, 134 after trimming and before the base plastic substrate is molded to the film inlay skins 114, 124, 134 to form the bodies 112, 122, 132.

The trimmed inlay skins 114, 124, 134 are loaded into an injection molding machine and are secured in place in their respective injection mold cavities using a static pinner, as is known in the industry. It should be understood that other means also can be used for securing the inlay skins in the mold cavities. For example, complementary locating tabs and receivers can be used on the inlay skins and mold cavities to hold the inlay skins in the mold cavities. A vacuum system also can be used, with small vacuum holes in the mold for drawing a vacuum against the inlay skins to hold the inlay skins in position. Standing steel cores can be used in the mold cavities as hangers for the pre-formed inlay skins. It is expected that still other systems and structures can be used to secure the positions of the inlay skins in the mold cavities.

With the inlays secured in the mold cavities and the mold closed, substrate material is injected into the mold and bonds to the inner surfaces of the inlay skins 114, 124, 134. After the molding process is finished, the tool opens and the finished parts are ejected. Return segments 118, 128, 138 extend sufficiently far that the segments 118, 128, 138 of adjacent parts 110, 120, 130 abut one against another in the completed assembly 100.

Suitably compatible films and plastic-based materials are used to achieve permanent chemical bonding between the film and the molded part. Accordingly, separation of the boundary between the molded plastic backing comprising the bodies 112, 122, 132 and the film inlay skins 114, 124, 134 is unlikely. Standard backing resins can be used, and suitably compatible films are available for bonding to the molten resin as the resin is injected. With suitable compatibility, a permanent bond is achieved. For example, an ABS resin can be used for bodies 112, 122, 132 and is compatible with ABS resin and PC/ABS films. A TPO resin can be used for bodies 112, 122, 132 and is compatible with standard polypropylene and compatible polypropylene variations such as PP/PE, PP+Talc or PP+E/P for films to make skins 114, 124, 134.

As noted previously, an in-mold decorating process as described herein eliminates the need for secondary operations such as painting, plating or other graphic application techniques. Parts are complete when molding of the base material is complete. The disadvantages of painting and plating processes, such as chemical-based waste disposal and VOC or other gaseous emissions, are eliminated. A finished, decorated product is ejected from the mold ready for shipment and use. In-mold decorating allows for a variety of colors, patterns and finishes to be used easily and quickly in the same tooling simply by applying a different film to the vacuum thermoforming mold and/or inserting different pre-prepared skins into the injection mold. Tool cleaning or complicated preparation is not required when changing decoration colors or patterns. Decorating is achieved without surface preparation when molten plastic is injected against the thermoformed film of the inlay skins.

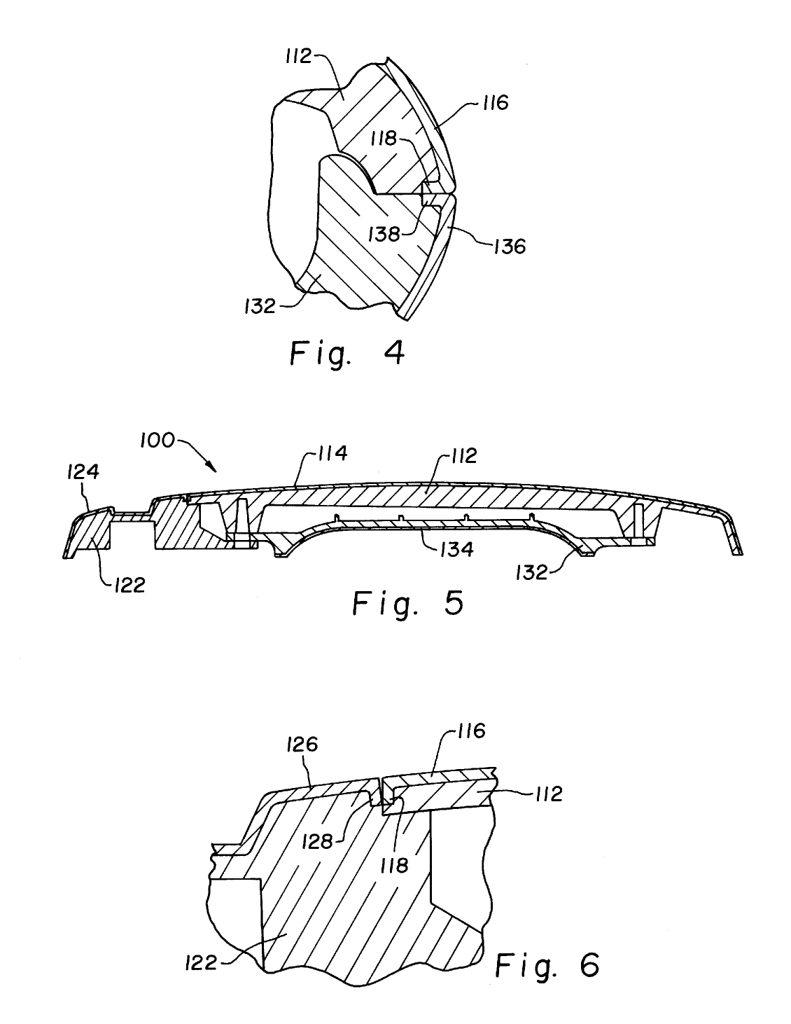

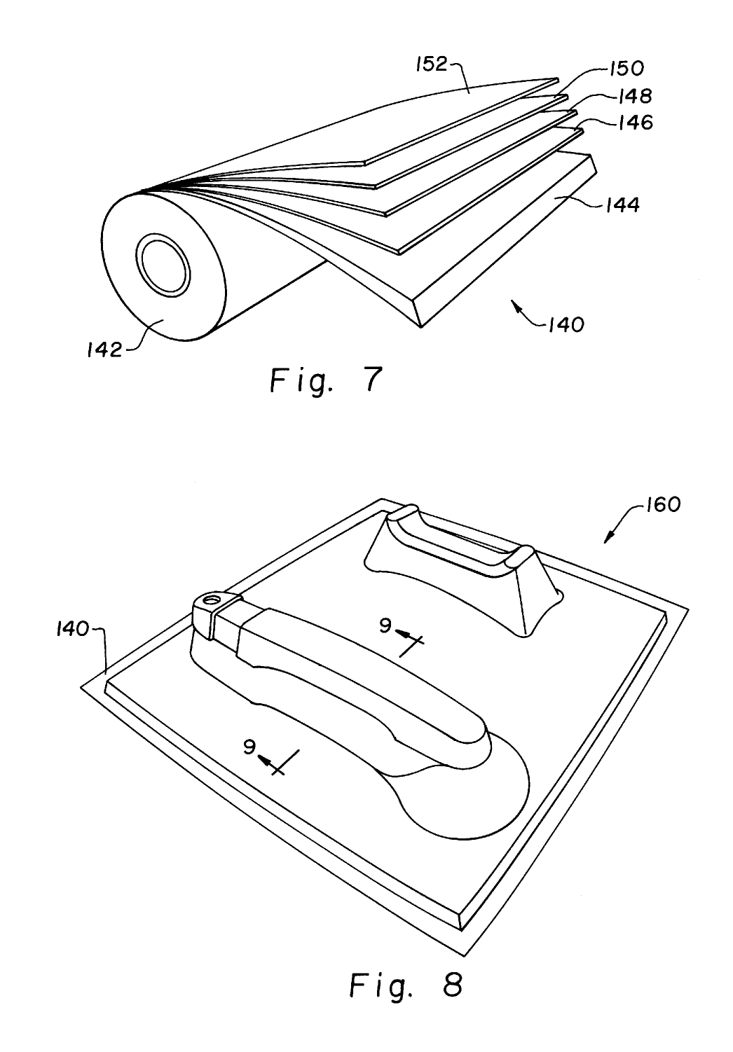

The decorative inlay skins 114, 124, 134 fully wrap portions of the edges of bodies 112, 122, 132 so that each part has a clean, fully decorated edge adjacent the outer visible surface. When two parts 110, 120, 130 are brought together, the adjacent wrapped edges of each meet one against the other and form a smooth line that shows no break in the decorative features, as can be seen in the enlarged cross-sectional views of FIGS. 4 & 6. Lower edge portions of the bodies 112, 122, 132 can abut against one another but are concealed from view by the abutted return segments 118, 128, 138.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A decorated part for an assembly including the part; said decorated part comprising:
a pre-formed skin made from a film having a desired decorative appearance, said skin formed independently in a shape of a desired visible surface of the assembly; and
a body of the part formed by molding against an inner surface of the pre-formed skin.

2. The decorated part of claim 1, said body having an edge, and said skin encompassing at least a portion of said edge.

3. The decorated part of claim 2, said film including an electrically conductive layer.

4. The decorated part of claim 1, said film including an electrically conductive layer.

5. The decorated part of claim 1, said body being bonded to said skin.

6. The decorated part of claim 5, said part having an edge, and said skin encompassing at least a portion of said edge.

7. The decorated part of claim 1, said part having an outer surface, and an edge; and said skin having an outer segment covering said outer surface and a return segment along at least a portion of said edge.

8. The decorated part of claim 7, said body being bonded to said skin.

9. An assembly of decorated parts; comprising:
at least a first part and a second part, each said part having a pre-formed skin and a body;
each said pre-formed skin being a vacuum formed inlay from a film having a desired decorative appearance;
each said body formed by molding plastic onto one of the pre-formed skins;
said parts having adjacent edges; and
said skins encompassing at least portions of said adjacent edges.

10. The assembly of claim 9, each of said parts having an outer surface and an edge adjacent said outer surface; and each said skin having an outer segment forming said outer surface and a return segment extending along at least a portion of said edge.

11. The assembly of claim 10, each of said bodies being bonded to a skin.

12. The assembly of claim 9, each of said bodies being bonded to a skin.

13. The assembly of claim 9, said first and second bodies having adjacent edges, said skins of said first and second parts having return segments along at least portions of said adjacent edges, and said return segments abutting one against the other in the assembly.

14. The assembly of claim 13, each of said bodies being bonded to a skin.

15. The assembly of claim 9, said first and second parts having edges adjacent each other in the assembly; said skins of said first and second parts having return segments along at least portions of said edges; and said return segments abutting one against the other in the assembly.

16. The assembly of claim 15, said edges of said first and second parts having edges of said bodies abutting one against the other in the assembly.

17. A process for manufacturing decorated parts; comprising:
thermoforming a decorative film into an inlay skin having the outer shape of at least a portion of the part;
loading the thermoformed skin into a plastic molding machine; and
injecting material for a body of the part into and against the thermoformed skin such that an outer surface and at least portions of edges of the finished part are covered by the thermoformed skin.

18. The process of claim 17, including a step of trimming the thermoformed skin before said step of loading the thermoformed skin into the plastic molding machine.

19. The process of claim 17, including a step of securing the thermoformed skin in the plastic molding machine.

20. The process of claim 17, including bonding the body to the thermoformed skin.
